(19) United States
(12) Patent Application Publication
(10) Pub. No.: US 2019/0070932 A1
(43) Pub. Date: Mar. 7, 2019

(54) LIQUID HEATING DEVICE

(71) Applicant: CALSONIC KANSEI CORPORATION, Saitama-shi, Saitama (JP)

(72) Inventor: Kojiro NAKAMURA, Saitama-shi, Saitama (JP)

(73) Assignee: CALSONIC KANSEI CORPORATION, Saitama-shi, Saitama (JP)

(21) Appl. No.: 16/084,212

(22) PCT Filed: Mar. 8, 2017
(86) PCT No.: PCT/JP2017/009237

§ 371 Date: Sep. 11, 2018

(30) Foreign Application Priority Data
Mar. 14, 2016 (JP) 2016-049865

(51) Int. Cl. B60H 1/22

(52) U.S. Cl. CPC B60H 1/2221; B60H 1/2218; B60H 2001/2268; B60H 2001/2246; B60H 2001/2228

(57) ABSTRACT

A liquid heating device includes: a liquid circulation circuit configured to allow circulation of antifreezing fluid therethrough; an electric heater provided in the liquid circulation circuit, the electric heater being configured to heat the antifreezing fluid circulating through the liquid circulation circuit; and a controller serving as a controlling unit configured to control output of the electric heater. The controller restricts the output of the electric heater when viscosity of the antifreezing fluid exceeds a predetermined threshold viscosity.

### TECHNICAL FIELD

The present invention relates to a liquid heating device.

### BACKGROUND ART

JP2001-171335A discloses a vehicle cabin-heating device that heats coolant water by applying current to an electric heater when cabin heating is required in a situation in which the temperature of the coolant water is still low after an engine has started, and so forth.

### SUMMARY OF INVENTION

However, with the vehicle cabin-heating device disclosed in JP2001-171335A, when current is applied to the electric heater when the temperature of the coolant water is low and the viscosity thereof is relatively high, there is a risk in that the coolant water near the electric heater is overheated due to insufficient circulation of the coolant water. Therefore, it is conceivable to provide an overheat protection switch on the electric heater and to gradually heat the coolant water by turning the electric heater ON and OFF by operating the overheat protection switch. However, in this case, there is a risk in that load is caused on a circuit of the electric heater by repeatedly turning the electric heater ON and OFF.

An object of the present invention is to provide a liquid heating device capable of preventing overheating of coolant water, and at the same time, capable of reducing load caused on a circuit of an electric heater.

According to one aspect of the present invention, a liquid heating device includes a liquid circulation circuit configured to allow circulation of liquid therethrough; a heating apparatus provided in the liquid circulation circuit, the heating apparatus being configured to heat the liquid circulating through the liquid circulation circuit; and a controlling unit configured to control output of the heating apparatus; wherein the controlling unit is configured to restrict the output of the heating apparatus when viscosity of the liquid exceeds a predetermined threshold value.

According to the above-mentioned aspect, because the output of the heating apparatus that heats the liquid circulating through the liquid circulation circuit is restricted when the viscosity of the liquid exceeds the predetermined threshold value, the liquid is prevented from being heated rapidly. Therefore, it is possible to suppress the overheating of the liquid. In addition, because an excessive increase of the temperature of the liquid is suppressed by heating the liquid by changing the output of the heating apparatus in accordance with the viscosity, the heating apparatus is not turned ON and OFF repeatedly even when the overheat protection switch is provided. Therefore, the heating apparatus can heat the liquid continuously without operating the overheat protection switch, and so, it is possible to heat the liquid without delay. As a result, it is possible to prevent the liquid from being overheated, and at the same time, to reduce the load caused on the circuit of the heating apparatus.

### BRIEF DESCRIPTION OF DRAWINGS

FIG. 1 is a configuration diagram of a liquid heating device according to an embodiment of the present invention.

FIG. 2 is a flowchart showing a flow of a heating restricting control of an electric heater of a fluid heating device.

FIG. 3 is an electric-power upper limit value property map showing a relationship between viscosity of antifreezing fluid and electric-power upper limit value.

FIG. 4 is a viscosity property table showing a relationship between temperature and the viscosity of the antifreezing fluid.

FIG. 5 is a pump-output property table showing a relationship between rotation speed and output of a pump that changes in accordance with the viscosity of the antifreezing fluid.

### DESCRIPTION OF EMBODIMENTS

An embodiment of the present invention will be described below with reference to the drawings.

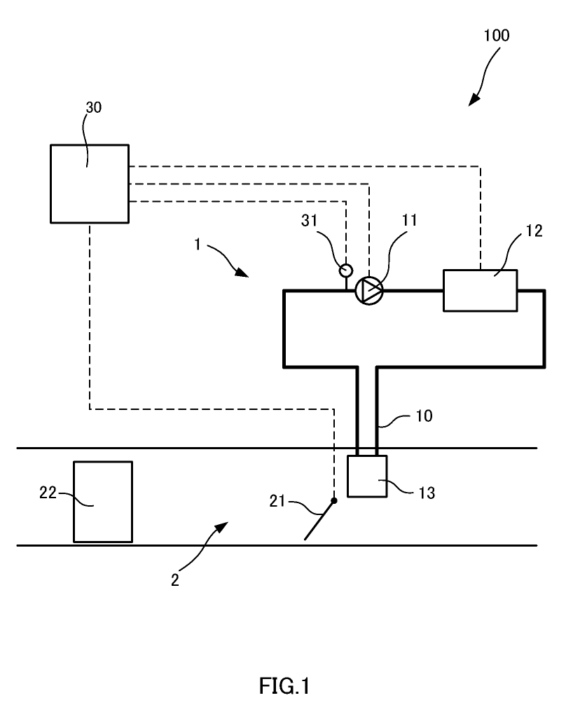

FIG. 1 is a configuration diagram of a liquid heating device 100 according to the embodiment of the present invention.

The liquid heating device 100 includes a liquid circulation circuit 1 through which liquid circulates. For example, antifreezing fluid that is a diluted aqueous solution of ethylene glycol is used as the liquid. In addition, the liquid heating device 100 is provided with, in combination, for example, an HVAC (Heating Ventilation and Air Conditioning) unit 2 through which air used for air-conditioning in a vehicle cabin flows.

The liquid circulation circuit 1 includes a pump 11, an electric heater 12, heater core 13, and a flow path 10 that connects these components such that the antifreezing fluid can circulates therethrough.

The pump 11 pumps and circulates the antifreezing fluid in the flow path 10.

The electric heater 12 has an inner heating portion (not shown) and heats the antifreezing fluid flowing therethrough. As the electric heater 12, for example, a sheathed heater or a PTC (Positive Temperature Coefficient) heater is used.

A heater core 13 is arranged in the HVAC unit 2, and warms the air to be sent into the vehicle cabin by causing the air passing through the heater core 13 to absorb the heat of the antifreezing fluid.

The air to be sent into the vehicle cabin is introduced to the HVAC unit 2. The HVAC unit 2 includes a blower (not shown) that sends the air and an air mix door 21 that adjusts the amount of the air passing through the heater core 13. In addition, an evaporator 22 and the heater core 13 are arranged in the HVAC unit 2, and the air sent from the blower is subjected to heat exchange with the cooling medium flowing in the evaporator 22 and with the coolant flowing in the heater core 13.

The air mix door 21 is provided on the blower side of the heater core 13 that is arranged in the HVAC unit 2. The air mix door 21 opens the heater core 13 side at a cabin-heating operation time and closes the heater core 13 side at a cabin-cooling operation time. By the opening degree of the air mix door 21, the amount of the heat exchange between the air and the antifreezing fluid in the heater core 13 is adjusted.

In the evaporator 22, at the cabin-cooling operation time, the air used for the vehicle-cabin air-conditioning is cooled by causing the cooling medium flowing through a refrigeration cycle (not shown) to absorb the heat of the air and evaporating the cooling medium.

The liquid heating device 100 is provided with a pump-inlet temperature sensor 31.

The pump-inlet temperature sensor 31 is provided at the inlet of the pump 11 and detects the temperature of the antifreezing fluid flowing into the pump 11.

The controller 30 includes a CPU (Central Processing Unit), a ROM (Read Only Memory), a RAM (Random Access Memory), and so forth, and various functions of the liquid heating device 100 are exhibited by reading out programs stored in the ROM with the CPU.

Signals from the pump-inlet temperature sensor 31 are input to the controller 30. The controller 30 respectively performs controls of the outputs of the pump 11, the electric heater 12, and the air mix door 21 on the basis of the input signals.

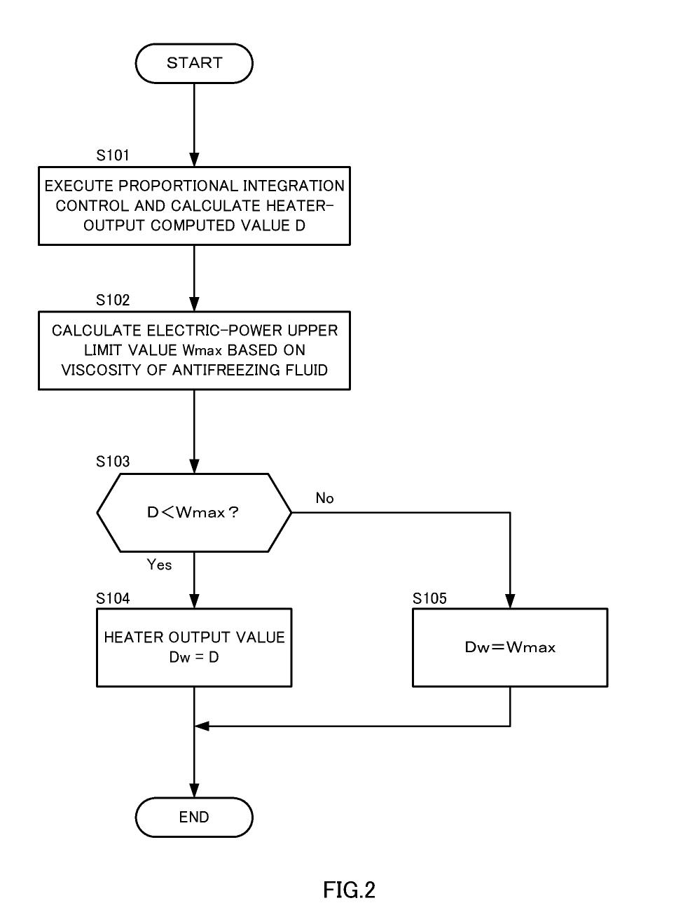

Next, a heating restricting control of the electric heater 12 performed by the controller 30 when the liquid heating device 100 is activated from the state in which the antifreezing fluid is cold will be described with reference to FIG. 2. FIG. 2 is a flowchart showing a flow of the heating restricting control of the electric heater 12. As the pump 11 is activated, the controller 30 performs the heating restricting control of the electric heater 12 shown in the flowchart in FIG. 2 at predetermined intervals.

In Step S101, the controller 30 executes a proportional integration control and calculates heater-output computed value D of the electric heater 12.

In the proportional integration control, the controller 30 obtains a deviation of the temperature of the antifreezing fluid from a target temperature and performs a proportional control such that the heater-output computed value D is increased as the deviation is increased. The controller 30 then performs an integration control to calculates the heater-output computed value D after the integration control by time integrating the offset caused by the proportional control and adding it to the heater-output computed value D.

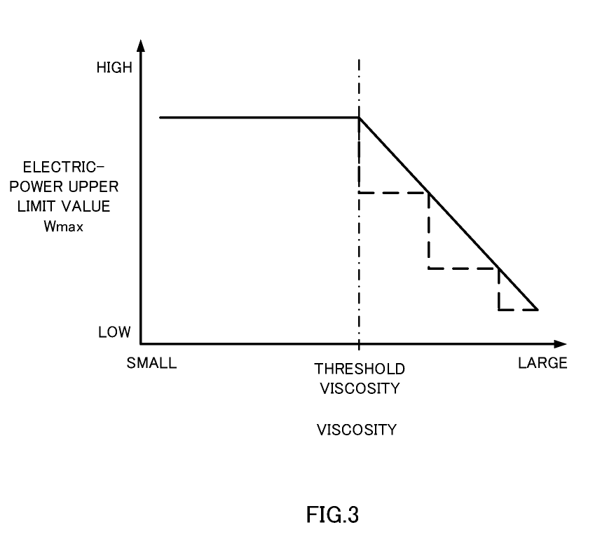

In Step S102, the controller 30 calculates, an electric-power upper limit value Wmax of the electric heater 12 on the basis of the viscosity of the antifreezing fluid. For example, the controller 30 obtains the electric-power upper limit value Wmax on the basis of an electric-power upper limit value property map shown in FIG. 3.

FIG. 3 is the electric-power upper limit value property map showing a relationship between the viscosity of the antifreezing fluid and the electric-power upper limit value Wmax. The horizontal axis in FIG. 3 is taken as the viscosity of the antifreezing fluid, and the vertical axis is taken as the electric-power upper limit value Wmax corresponding to the temperature of the antifreezing fluid.

As shown in FIG. 3, the electric-power upper limit value Wmax is set in advance so as to be restricted to a lower value as compared with the case in which the viscosity of the antifreezing fluid is equal to or less than the threshold viscosity when the viscosity of the antifreezing fluid exceeds a predetermined threshold viscosity. In addition, as shown by solid line in FIG. 3, the electric-power upper limit value Wmax in the case in which the viscosity of the antifreezing fluid exceeds a predetermined threshold viscosity is set so as to be lowered as the viscosity of the antifreezing fluid is increased. As shown by broken line in FIG. 3, the electric-power upper limit value Wmax may be set so as to be lowered stepwise as the viscosity of the antifreezing fluid is increased.

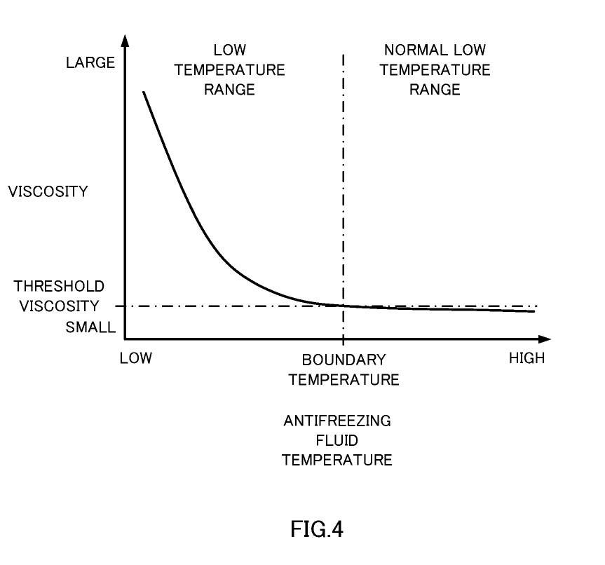

Here, although the viscosity of the antifreezing fluid changes in accordance with the temperature, the physical property thereof differs based on its liquid type of the antifreezing fluid. Thus, the ROM in the controller 30 stores, for example, a viscosity property table such as that shown in FIG. 4. In the viscosity property table, the viscosities of the antifreezing fluid to be used are plotted against temperatures in advance.

FIG. 4 is a viscosity property table showing a relationship between the temperature and the viscosity of the antifreezing fluid. The horizontal axis in FIG. 4 is taken as the temperature of the antifreezing fluid, and the vertical axis is taken as the viscosity of the antifreezing fluid.

In a low temperature range in which the temperature of the antifreezing fluid is relatively low, as shown in FIG. 4, the viscosity of the antifreezing fluid exceeds the threshold viscosity and is rapidly increased as the temperature of the antifreezing fluid is decreased. Therefore, for example, in the case in which the pump 11 and the electric heater 12 are started in a cold region after they have been stopped for a long period of time, the temperature of the antifreezing fluid reaches the low temperature range, and the viscosity of the antifreezing fluid is increased greatly so as to exceed the threshold viscosity.

On the other hand, in a normal temperature range that is a temperature range under a normal usage, the viscosity of the antifreezing fluid reaches the viscosity equal to or less than the threshold viscosity, and the viscosity of the antifreezing fluid changes gradually in accordance with the change in the temperature.

As described above, the low temperature range and the normal temperature range are set on the basis of the threshold viscosity. A boundary temperature is set on the boundary between the low temperature range and the normal temperature range.

As shown in Step S102 in FIG. 2, the controller 30 refers to the viscosity property table shown in FIG. 4 and obtains the viscosity of the antifreezing fluid on the basis of the temperature of the antifreezing fluid at the inlet of the pump 11 that is detected by the pump-inlet temperature sensor 31.

In Step S103, the controller 30 determines whether or not the heater-output computed value D is not exceeding the electric-power upper limit value Wmax. The processing by the controller 30 proceeds to Step S104 if the heater-output computed value D is not exceeding the electric-power upper limit value Wmax, in other words, the heater-output computed value D is equal to or less than the electric-power upper limit value Wmax. On the other hand, if the heater-output computed value D is exceeding the electric-power upper limit value Wmax, the processing proceeds to Step S105.

In Step S104, with the controller 30, the value of the heater-output computed value D is substituted for heater output value Dw. Therefore, the electric heater 12 heats the antifreezing fluid by outputting the heater output value Dw while maintaining the heater-output computed value D that is not restricted. Therefore, the antifreezing fluid is heated rapidly. Subsequently, the controller 30 terminates the heating restricting control of the electric heater 12.

In Step S105, with the controller 30, the value of the electric-power upper limit value Wmax is substituted for the heater output value Dw. The electric heater 12 heats the antifreezing fluid by outputting the heater output value Dw on the basis of the value of the electric-power upper limit value Wmax that is restricted to a lower value on the basis of the temperature of the antifreezing fluid. Therefore, the antifreezing fluid is heated gradually. Subsequently, the controller 30 terminates the heating restricting control of the electric heater 12.

With the liquid heating device 100 described above, following effects can be achieved.

The liquid heating device 100 includes: the liquid circulation circuit 1 configured to allow circulation of the antifreezing fluid therethrough; the electric heater 12 provided in the liquid circulation circuit 1, the electric heater 12 being configured to heat the antifreezing fluid circulating through the liquid circulation circuit 1; and the controller 30 serving as a controlling unit configured to control the output of the electric heater 12. The controller 30 is configured to restrict the output of the electric heater 12 when the viscosity of the antifreezing fluid exceeds the predetermined threshold value.

According to the liquid heating device 100, because the output of the electric heater 12 configured to heat the antifreezing fluid circulating through the liquid circulation circuit 1 is restricted when the viscosity of the antifreezing fluid exceeds the predetermined threshold viscosity, the antifreezing fluid is prevented from being heated rapidly. Therefore, it is possible to suppress overheating of the antifreezing fluid. In addition, because the liquid is heated by changing the output of the electric heater 12 in accordance with the viscosity, thereby suppressing an excessive temperature increase of the antifreezing fluid, it is possible to avoid repetitive ON and OFF of the electric heater 12 even if an overheat protection switch is provided. Therefore, it is possible to continuously heat the antifreezing fluid by the electric heater 12 without operating the overheat protection switch, and so, the antifreezing fluid is heated without delay. As a result, it is possible to prevent the antifreezing fluid from being overheated, and at the same time, it is possible to reduce the load caused on the circuit of the electric heater 12.

With the liquid heating device 100, the controller 30 performs restriction such that an upper limit of the output of the electric heater 12 is decreased as the viscosity of the antifreezing fluid is increased to exceed the predetermined threshold viscosity. Therefore, according to the liquid heating device 100, as the viscosity of the antifreezing fluid is increased at a low-temperature start time, etc., the electric heater 12 heats the antifreezing fluid more gradually, and therefore, even in the case in which a flowability of the antifreezing fluid is lowered considerably, it is possible to prevent the antifreezing fluid from being overheated, and at the same time, it is possible to suppress the load caused on the circuit of the electric heater 12.

In addition, with the liquid heating device 100, the controller 30 is configured to estimate the viscosity of the antifreezing fluid based on the temperature of the antifreezing fluid. According to such liquid heating device 100, by detecting the temperature of the antifreezing fluid in the liquid circulation circuit 1, it is possible to estimate the viscosity of the antifreezing fluid easily and it is possible to control the electric heater 12 on the basis of the viscosity of the antifreezing fluid.

Furthermore, with the liquid heating device 100, the controller 30 estimates the viscosity of the antifreezing fluid based on the temperature of the antifreezing fluid at the inlet of the pump 11. The antifreezing fluid at the inlet of the pump 11 is in a state in which the heat thereof has been released in the heater core 13, and therefore, a viscosity resistance of the antifreezing fluid is the largest because the temperature of the antifreezing fluid is the lowest in the liquid circulation circuit 1. Therefore, the output of the pump 11 can be adjusted by obtaining the largest viscosity resistance in the liquid circulation circuit 1 from the estimated viscosity, and so, it is possible to allow the antifreezing fluid to circulate through the liquid circulation circuit 1 at a desired flow rate with high accuracy.

By using another temperature sensor (not shown) than the pump-inlet temperature sensor 31, the controller 30 may detect the temperature of the antifreezing fluid at any position between an inlet of the electric heater 12 and the inlet of the pump 11, and on the basis of this detected temperature, the controller 30 may estimate the viscosity of the antifreezing fluid at the inlet of the pump 11 positioned at the upstream side. Because the temperature of the antifreezing fluid at an outlet of the pump 11 is increased due to the heat loss caused by the work of the pump 11, it is possible to obtain the temperature of the antifreezing fluid at the inlet of the pump 11 by subtracting the amount corresponding to the heat loss from the temperature detected by the another temperature sensor. Therefore, by estimating the viscosity at the inlet of the pump 11 from the temperature of the antifreezing fluid thus obtained, it is possible to adjust the output of the pump 11 by taking the largest viscosity resistance in the liquid circulation circuit 1 into consideration.

Although the embodiment of the present invention has been described in the above, the above-mentioned embodiment merely illustrates a part of application examples of the present invention, and the technical scope of the present invention is not intended to be limited to the specific configuration in the above-mentioned embodiment.

In the above-mentioned embodiment, although the controller 30 obtains the temperature of the antifreezing fluid at the inlet of the pump 11 on the basis of the viscosity of the antifreezing fluid, the viscosity of the antifreezing fluid may be obtained in a different manner.

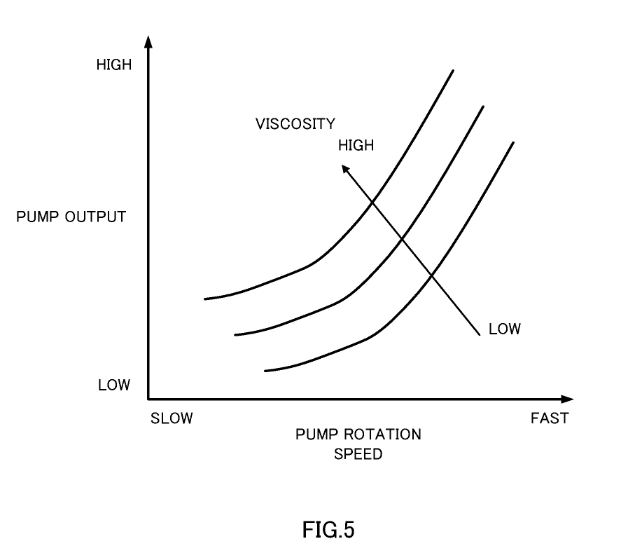

For example, the controller 30 may refer to a property table shown in FIG. 5 and may estimate the viscosity of the antifreezing fluid on the basis of the output and the rotation speed of the pump 11.

FIG. 5 is the pump-output property table showing a relationship between the rotation speed and the output of the pump 11 that changes in accordance with the viscosity of the antifreezing fluid. The horizontal axis in FIG. 5 is taken as the rotation speed of the pump 11, and the vertical axis is taken as the output of the pump 11. As shown in FIG. 5, the faster the rotation speed, the higher the output of the pump 11 becomes. Here, when the viscosity of the antifreezing fluid is high, the load is increased due to the increased viscosity resistance as compared with the case in which the viscosity is low, the output becomes higher even at the same rotation speed. The controller 30 calculates the output from an indicator current from the pump 11 and detects the rotation speed of the pump 11 with a rotation sensor (not shown). By referring to the property table shown in FIG. 5, it is possible to estimate the viscosity of the antifreezing fluid on the basis of thus calculated output of the pump 11 and the detected rotation speed. According to such an aspect, it is possible to estimate the viscosity of the antifreezing fluid without using the temperature sensor.

In addition, in the liquid circulation circuit 1, the antifreezing fluid circulating through the liquid circulation circuit 1 may be heated by providing the heat exchanger (not shown) together with the electric heater 12. In this case, the heat exchanger is provided so as to be able to perform the heat exchange between cooling medium circulating through a heat pump cycle (not shown) or coolant water circulating through a cooling circuit (not shown) for a driving source, such as an engine, and the antifreezing fluid circulating through the liquid circulation circuit 1, for example. Also according to such an aspect, it is possible to gradually heat the antifreezing fluid without causing the load on the circuit of the electric heater 12.

The above-mentioned embodiments may be combined appropriately.

This application claims priority based on Japanese Patent Application No. 2016-049865 filed with the Japan Patent Office on Mar. 14, 2016, the entire contents of which are incorporated into this specification.

1. A liquid heating device comprising:
a liquid circulation circuit configured to allow circulation of liquid therethrough;
a heating apparatus provided in the liquid circulation circuit, the heating apparatus being configured to heat the liquid circulating through the liquid circulation circuit; and
a controlling unit configured to control output of the heating apparatus; wherein
the controlling unit is configured to restrict the output of the heating apparatus when viscosity of the liquid exceeds a predetermined threshold value.

2. The liquid heating device according to claim 1, wherein
the controlling unit is configured to perform restriction such that an upper limit of the output of the heating apparatus is decreased as the viscosity of the liquid is increased to exceed the predetermined threshold value.

3. The liquid heating device according to claim 1, wherein the controlling unit is configured to estimate the viscosity of the liquid based on temperature of the liquid.

4. The liquid heating device according to claim 3, further comprising:
a pump provided on upstream side of the heating apparatus, the pump being configured to circulate the liquid through the liquid circulation circuit, wherein
the controlling unit is configured to estimate the viscosity of the liquid at an inlet of the pump based on the temperature of the liquid at any position between an inlet of the heating apparatus and the inlet of the pump.

5. The liquid heating device according to claim 4, wherein
the controlling unit is configured to estimate the viscosity of the liquid based on the temperature of the liquid at the inlet of the pump.

6. The liquid heating device according to claim 4, wherein
the controlling unit is configured to estimate the viscosity of the liquid based on output of the pump and rotation speed of the pump.
